(19) United States
(12) Patent Application Publication
(10) Pub. No.: US 2015/0009332 A1
(43) Pub. Date: Jan. 8, 2015

(54) APPARATUS, METHOD AND SYSTEM FOR MONITORING PRESENCE OF PERSONS IN AN AREA

(71) Applicant: KONINKLIJKE PHILIPS N.V., EINDHOVEN (NL)

(72) Inventor: Peter Jens Fuhrmann, Aachen (DE)

(21) Appl. No.: 14/376,161

(22) PCT Filed: Feb. 19, 2013
(86) PCT No.: PCT/IB2013/051321

§ 371 Date: Aug. 1, 2014

Related U.S. Application Data
(60) Provisional application No. 61/604,606, filed on Feb. 29, 2012.

(51) Int. Cl. G07C 9/00; G08B 21/22

(52) U.S. Cl. CPC G07C 9/00; G08B 21/22
USPC 348/155

(57) ABSTRACT

For monitoring presence of persons in an area, the area is subdivided into at least two sub-areas and, for each of the at least two sub-areas, at least one detection line is defined with regard to a boundary of the corresponding sub-area. The detection line marks an entry to and/or exit from the corresponding sub-area. Within the scope of the monitoring, it is detected whether a moving person is entering or exiting the corresponding sub-area by use of the at least one detection line of the corresponding sub-area and/or whether the moving person is expected to enter or exit the corresponding sub-area by use of the at least one detection line of the corresponding sub-area.

### FIELD OF THE INVENTION

The invention relates to an apparatus, method and system arranged for monitoring presence of persons in an area.

### BACKGROUND OF THE INVENTION

Lighting and advanced building controls like energy and building utilization monitoring, for example, or service opportunities, which require accurate knowledge of the building usage or continuous monitoring and surveillance of the building operations, have become more and more sophisticated and tailored to the actual space utilization and the individual needs of occupants in the building. The goal of such control systems is to provide an optimal environment to the persons staying in the building, for example, by providing optimal lighting or room temperature in dependence on occupancy of a room, in dependence on number of persons staying in the room and/or in dependence on where the persons are in the room. Offices and work spaces are usually clearly structured and task areas are unambiguously defined, e.g. through desk placement. The task area represents a suitable granularity for personalized and occupant-tailored controls. Thus, presence of persons in task areas (and overall presence) is crucial information to know.

Robust low-cost sensor solutions for detecting the presence and/or number of persons in a room or area and for detecting the presence and/or number of persons in task areas or sub-areas of the room or area are required. Said sensor solutions should be addressable with dedicated control means. This need applies to both non-permanently installed monitoring systems (used, for example, to audit a building and its utilization) and permanently installed, advanced real-time control applications (for example, presence-controlled task lighting or demand-led ventilation).

Known standard approaches for presence sensing, which reveal binary information about whether a room is occupied or not, are not suitable for concepts targeting individual task areas and/or demand-led schemes that depend on the number of persons in a room (e.g. ventilation control).

When known dedicated presence sensors are used, it is necessary that for each individual task area a corresponding dedicated presence sensor is installed. Therefore, the use of said dedicated presence sensors leads to an expensive solution with regard to the number of components to be installed and with regard to maintenance of the installed components.

Known high-resolution camera-based solutions may comprise components for localization, tracking and/or counting of persons. However, the high-resolution camera-based solutions are still expensive and inherently involve privacy issues due to the recognizablility of persons monitored via the high-resolution cameras. These disadvantages make high-resolution camera-based solutions unattractive from both the point of view of the investors (particularly due to the high implementation costs) and the point of view of the users (particularly due to the low acceptance).

Known traditional sensor solutions for counting people are either unreliable and require complex installation measures (e.g. double laser gates) or cannot easily provide the localization information.

Further, known person counters based on simple infrared (IR) imaging have only a small coverage area (e.g. limited by the ceiling light) and provide single in/out information only, i.e., information of whether a person has entered (referred to also as “in-information”) or exited (referred to also as “out-information”) an area or room, respectively.

JP 11219437 A, for example, discloses a system for counting persons, utilizing n infrared cameras, each camera being installed in its own monitoring area, and a counter analyzing images of the n cameras.

Thus, there is still a need for improved solutions for presence monitoring of persons in an area or room, which preclude and solve at least the above-outlined disadvantages of known monitoring systems and solutions.

### SUMMARY OF THE INVENTION

It is an object of the present invention to provide an improved solution for monitoring presence of persons in an area or room.

The object is achieved by the features of the independent claims.

The present invention is based on segregation of the area or room to be monitored, i.e., the area or room is divided into several sub-areas or sub-rooms respectively. Further, the invention comprises a tailored person localization concept, according to which directional movement sensing or detection is implemented (e.g., by use of a directional movement sensor as a monitoring apparatus). In this way, the coverage or observation area of an apparatus monitoring the presence of persons, like a sensor, for example, may be smaller than the monitored area or room. Further, it is not mandatory that the coverage or observation area of the apparatus covers the whole monitored area and/or monitored sub-areas or sub-rooms with the persons. According to the present invention, it is sufficient to monitor (and, thus, to cover) entrances and exits of the sub-areas or sub-rooms, as, for monitoring purposes, the present invention exploits information on entering and exiting events of the sub-areas or sub-rooms to calculate a state of occupancy of the sub-areas or sub-rooms respectively. This can be derived by executing directional movement sensing or detection without monitoring/surveillance of the (whole) area or room and/or without monitoring/surveillance of at least one (whole) sub-area or sub-room. In this way, the sub-area, in which a person is located, is preserved as a privacy shell.

In one aspect of the present invention, an apparatus arranged for monitoring presence of persons in an area is provided, wherein the area is subdivided into at least two sub-areas and wherein, for each of the at least two sub-areas, at least one detection line is defined with regard to a boundary of the corresponding sub-area, the detection line marking an entry and/or exit of the corresponding sub-area, and the apparatus is configured to execute a detection step to detect whether a moving person is entering or exiting the corresponding sub-area by use of the at least one detection line of the corresponding sub-area and/or to detect whether the moving person is expected to enter or exit the corresponding sub-area by use of the at least one detection line of the corresponding sub-area. Said apparatus of the present invention allows efficient and low-cost detection of presence of persons in an area, wherein the presence may refer to an actual current presence of persons in the area and/or to a predicted or expected presence, wherein, from the movement direction, it is detected where a person is moving to. Further, reliable detection of entering and/or exiting events is enabled, particularly, by implementing the subdivision into sub-areas and utilizing detection lines associated with the sub-areas. The entering and/or exiting events may refer to already occurred entering and/or exiting events of the corresponding sub-area (and/or area) and/or to a predicted or expected entering and/or exiting event of the corresponding sub-area (and/or area). Further, detection according to the present invention can be implemented in an efficient and resource-saving way, without requiring complex computations. The solution of the present invention does not necessarily require implementing person recognition and, therefore, does not violate the privacy of persons entering and/or exiting the monitored area. Furthermore, by use of the detection lines and the subdivision of the monitored area into sub-areas according to the present invention, reliable detection of persons entering and/or exiting the monitored area and/or the sub-areas is ensured.

According to an embodiment of the present invention, the apparatus is configured to: detect the person as entering the corresponding sub-area, when the person is crossing the at least one detection line of the corresponding sub-area by moving towards or into the corresponding sub-area; detect the person as exiting the corresponding sub-area, when the person is crossing the at least one detection line of the corresponding area by moving out of or away from the corresponding sub-area; detect the person as being expected to enter the corresponding sub-area, when it is calculated that the person is moving to the at least one detection line of the corresponding sub-area by moving towards the corresponding sub-area; and/or detect the person as being expected to exit the corresponding sub-area, when it is calculated that the person is moving to the at least one detection line of the corresponding area by moving towards an exit of the corresponding sub-area. By detecting already occurred crossings and/or expected/predicted crossings of detection lines as entering or exiting events, an efficient, fast and computing time and space-saving detection is enabled.

According to an embodiment of the present invention, the apparatus is further configured to determine whether: the person is entering or exiting the area; the person is expected to enter or exit the area; the person is moving from one sub-area to another sub-area; and/or the person is expected to move from one sub-area to another sub-area. In this way, reliable monitoring of presence of persons is enabled, as it is distinguished into entering/exiting and switching events in the area.

According to an embodiment of the present invention, the apparatus is configured to execute the detection step by use of at least one of the following: a set of directional relationships between the area and the at least two sub-areas; and/or a set of entry and/or exit conditions for the area and/or the at least two sub-areas. In this way, the reliability and correctness of the detected entering and/or exiting events is supported.

According to an embodiment of the present invention, at least one directional relationship of the set of directional relationships specifies at least one of the following: location of the corresponding sub-area in the area, and/or at least one path leading to the corresponding sub-area in the area. According to an embodiment of the present invention, the at least one of the entry and/or exit conditions specifies at least one entrance and/or at least one exit of the area and/or of the corresponding sub-area. The at least one path may be a path from an entry of the area to the corresponding sub-area or a path from a further sub-area to the corresponding sub-area. Further, the at least one path may/should cross the at least one detection line of the corresponding sub-area. Furthermore, for entering and/or exiting the corresponding sub-area, it may be specified as a condition that the at least one detection line of the corresponding sub-area may/should be crossed from one specific side of said detection line to another specific side of said detection line and/or in at least one specific direction.

According to an embodiment of the present invention, the apparatus is configured to execute the detection step by calculating a movement trajectory of the person. In this way, a correct, efficient and low-cost detection is enabled without violating the privacy of the person monitored.

According to an embodiment of the present invention, the apparatus is configured to execute the detection step by measuring a time interval between a crossing of one detection line and a further crossing of a further detection line for entering the corresponding sub-area and by using the measured time interval for calculating a target sub-area, towards which the person moves. In this way, the reliability and correctness of detection results is ensured in an efficient way.

According to an embodiment of the present invention, the apparatus is arranged to monitor the presence of persons in an observation area of the apparatus. The observation area may be comprised in the area or may overlap with the area. The observation area corresponds to an area which the apparatus can sense or recognize. In this way, the monitoring and detection steps do not require extensive calculations with regard to observations in the whole area and can be performed in an efficient way.

According to an embodiment of the present invention, the at least one detection line is defined with regard to a border of the observation area; the set of directional relationships is specified with regard to the observation area; the at least one path is comprised in the observation area; the set of directional relationships comprises at least one directional relationship specifying the direction to the location of the corresponding sub-area in the observation area; the set of entry and/or exit conditions is specified with regard to the observation area; and/or the movement trajectory is calculated in the observation area. In this way, the detection step concentrates on the observation area only. Relating the plurality of additional information to the observation area and detecting in the observation area result in an efficient and at the same time reliable detection.

According to an embodiment of the present invention, the observation area is implemented as a grid. Sectors of the grid may have the shape of polygons. In this way, a simple and at the same time effective and flexible implementation of the observation area is provided.

According to an embodiment of the present invention, the apparatus is configured to: recalculate the grid of the observation area by subdividing the grid into smaller segments than the segments currently used in the grid and/or by subdividing the grid into larger segments than the segments currently used in the grid; subdivide the detection line into at least two new detection lines for using the at least two new detection lines for detection purposes; and/or join at least two detection lines into one detection line for using the one detection line for detection purposes. Thereby, a flexible and reliable implementation of detection of entering and/or exiting events is enabled. Particularly, both a rough and a fine detection may be performed, wherein it is easy to switch between the rough and the fine detecting modes.

According to an embodiment of the present invention, each sub-area of the at least two sub-areas has the shape of a polygon.

According to an embodiment of the present invention, two of the at least two sub-areas are neighboring sub-areas and/or the at least two sub-areas are interconnected sub-areas.

According to an embodiment of the present invention, the apparatus comprises a directional movement sensor, which is configured to execute the detection step, wherein the directional movement sensor may be an ultra-low-resolution imaging sensor, wherein the ultra-low-resolution imaging sensor may be an infrared sensor and/or a camera-based sensor. In this way, effective integration of already existing components is enabled. Thus, stable implementation of the present invention becomes possible, as it is not mandatory to introduce new components carrying the risk of hitherto undetected erroneous or incomplete operation.

In a further aspect of the present invention, a method of monitoring presence of persons in an area is provided, wherein the area is subdivided into at least two sub-areas and wherein, for each of the at least two sub-areas, at least one detection line is defined with regard to a boundary of the corresponding sub-area, the detection line marking an entry and/or exit of the corresponding area, and the method comprises detecting whether a moving person is entering or exiting the corresponding sub-area by use of the at least one detection line of the corresponding sub-area and/or whether the moving person is expected to enter or exit the corresponding sub-area by use of the at least one detection line of the corresponding sub-area.

In another aspect of the present invention, a system comprising an apparatus arranged for monitoring presence of persons in an area is provided, wherein the apparatus corresponds to the monitoring apparatus-outlined above and described in more detail hereinbelow.

According to an embodiment of the present invention, the system is configured to compute information on presence of persons in the area and/or in the sub-areas by executing at least one of the following: counting a number of persons in the area and/or a number of persons in at least one of the at least two sub-areas; calculating the state of occupancy of the area and/or of at least one of the at least two sub-areas; monitoring changes of the occupancy of the area and/or of at least one of the at least two sub-areas over a time period; correcting, by use of a current detection result, at least one of the following: the number of persons in the area and/or the number of persons in at least one of the at least two sub-areas, the state of occupancy of the area and/or of at least one of the at least two sub-areas; and/or wherein the system is configured to compute information on expected presence of persons in the area and/or in the sub-areas by executing at least one of the following: calculating an expected number of persons in the area and/or an expected number of persons in at least one of the at least two sub-areas; calculating an expected state of occupancy of the area and/or of at least one of the at least two sub-areas; correcting, by use of a current detection result, at least one of the following: the expected number of persons in the area and/or the expected number of persons in at least one of the at least two sub-areas, and the expected state of occupancy of the area and/or of at least one of the at least two sub-areas.

According to an embodiment of the present invention, the system is configured to transmit the computed information on presence of persons in the area and/or in the sub-areas to a controlling apparatus, which is configured to control at least one controlled apparatus installed in the area by adjusting operation of the controlled apparatus with regard to the presence of persons in the area and/or in the at least two sub-areas and/or with regard to the computed expected presence of persons in the area and/or in the at least two sub-areas.

By use of the present invention, the drawbacks of known systems indicated above may be overcome. Further, the present invention enables efficient, computation-time-and-space saving and low-cost detection of presence of persons in an area. According to the present invention, the detection results have a high reliability and accuracy. Furthermore, the detection according to the present invention does not violate privacy of persons entering and/or exiting the monitored area and/or sub-areas. Additionally, for detection purposes, the present invention allows the use of already existing components and does not necessarily require utilizing new components, since the operation of the latter has not been sufficiently tested and, therefore, may be erroneous or incomplete. Moreover, flexible detection is enabled by the present invention. For example, it enables easy switching between several levels of accuracy during executing a detecting operation, as the present invention allows switching between a rougher and a finer detection.

### BRIEF DESCRIPTION OF THE DRAWINGS

In the drawings:

FIG. 1 illustrates a process executed in connection with monitoring presence of persons in an area according to an embodiment of the present invention;

FIG. 2 illustrates the processing of information required for monitoring presence of persons in an area according to an embodiment of the present invention.

FIG. 3 illustrates an arrangement utilizing the step of monitoring presence of persons in an area according to an embodiment of the present invention;

FIG. 4 illustrates a system arranged for monitoring presence of persons in an area according to an embodiment of the present invention;

FIGS. 5a and 5b illustrate subdividing of an area into sub-areas according to an embodiment of the present invention;

FIGS. 6a and 6b illustrate detecting entering and/or exiting events according to the embodiment of the present invention;

FIGS. 7a and 7b illustrate detecting entering and/or exiting events according to an embodiment of the present invention;

FIG. 8a illustrates the observation area of FIGS. 7a and 7b in more detail;

FIG. 8b illustrates an observation area according to an embodiment of the present invention referring by way of example to FIGS. 7a and 7b;

FIG. 8c illustrates an exemplary detection in the observation area of FIGS. 7a and 7b.

FIG. 9 illustrates monitoring presence of persons in an area according to an embodiment of the present invention;

FIG. 10 illustrates monitoring presence of persons in an area according to an embodiment of the present invention; and

FIG. 11 shows an IR heat image with identified persons, which may be used for detection according to an embodiment of the present invention.

### DETAILED DESCRIPTION OF THE EMBODIMENTS

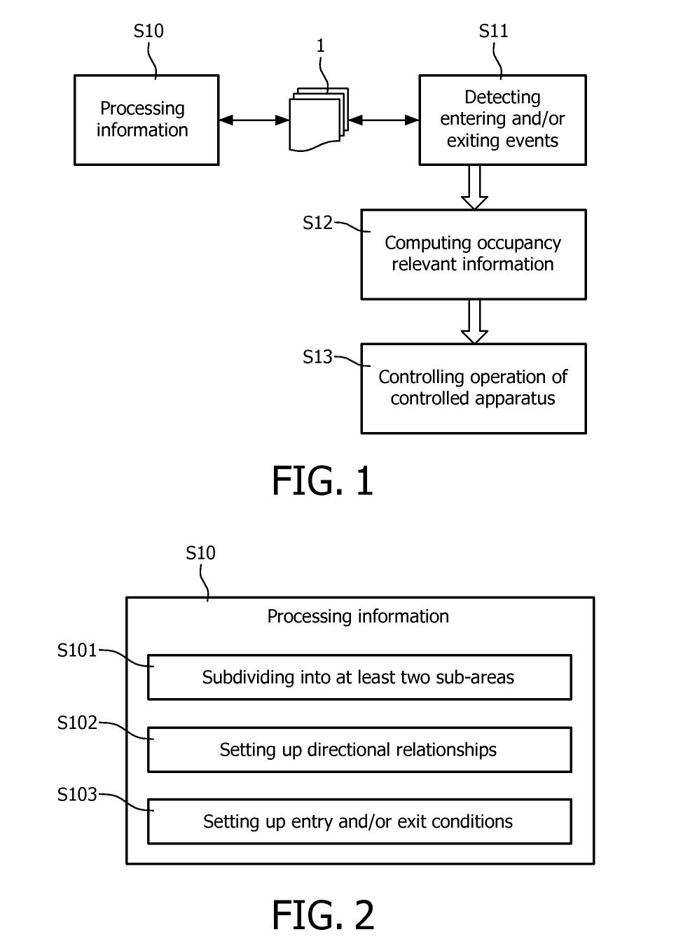

FIG. 1 illustrates a process executed in connection with monitoring presence of persons in an area according to an embodiment of the present invention. According to the present embodiment, on one side, information 1 required for performing the monitoring is processed S10 (e.g. derived and/or calculated) and provided for monitoring purposes. The processing of information 1 may be executed by an apparatus for monitoring presence of persons or by a monitoring system comprising said apparatus, wherein in the latter case the apparatus for monitoring presence of persons receives said information 1 from the monitoring system. Additionally, it is possible that a part of the information 1 is processed by the apparatus for monitoring presence of persons and that another part of the information 1 is processed by the information processing apparatus and provided to the apparatus for monitoring presence of persons. The apparatus for monitoring presence of persons may comprise, for example, at least one processor or processing unit configured to perform the processing.

FIG. 2 illustrates the processing S10 of information 1 required for performing the monitoring according to an embodiment of the present invention. The information processing S10 may comprise subdividing or segregating S101 an area, with regard to which the monitoring of the presence of persons is executed, into at least two sub-areas. A room of an office, for example, may be subdivided S101 into task areas as the at least two sub-areas. The task areas may be defined, for example, through desk placement. In this exemplary case, the monitoring of presence of persons refers to observing occupancy in desk areas, which allows a more specific and effective control of the environment (e.g. light, temperature etc.) of the corresponding desk areas. Thus, in step S10, information on at least two subdivided sub-areas is provided.

Further, the information processing S10 may comprise setting up S102 (e.g. identifying and/or defining) directional relationships between the area (e.g. an entry and/or exit of the area) and the subdivided at least two sub-areas (e.g. at least one entry and/or exit of the at least two sub-areas). The directional relationships may specify at least one of the following:

location of a sub-area in the area;

at least one relation between an entry and/or exit of the area and a sub-area of the area, wherein said relation may specify the direction from the entry and/or exit of the area to the sub-area, the direction from the sub-area to the entry and/or exit of the area, the direction from the entry and/or exit of the area to an entry and/or exit of the sub-area, and/or the direction from the entry and/or exit of the sub-area to the entry and/or exit of the area;

at least one path from the entry and/or exit of the area to a sub-area (e.g. to an entry and/or exit of the sub-area);

at least one path from a sub-area (e.g. from an entry and/or exit of the sub-area) to the entry and/or exit of the area; and/or

at least one path from one sub-area (e.g. from an entry and/or exit of the one sub-area) to another sub-area (e.g. to an entry and/or exit of the another sub-area).

The paths and/or directions may be given such that at least one detection line defined for the corresponding sub-area is/may be crossed.

The apparatus for monitoring presence of persons in the area may be configured to observe only a part of the area, i.e., the apparatus may have an observation area in the area. The observation area may cover the whole area and/or may cover a part of the area. According to an embodiment, the apparatus may be located, for example, at an entry and/or exit of the monitored area. In this case, the apparatus may have an observation area, by use of which entering and/or exiting the area and/or moving towards and/or from the sub-areas may be monitored.

The setting up S102 of the directional relationships may be done with regard to the observation area. Thus, the location of a sub-area may be provided by describing the direction from the observation area to the sub-area and/or the direction from the sub-area to the observation area. Similarly, the at least one relation between an entry and/or exit of the area and a sub-area of the area may be set up with regard to the observation area. Further, the paths, as described exemplarily hereinabove, may be set up with regard to the observation area, e.g., the paths and/or parts thereof may be comprised in the observation area.

Furthermore, the information processing S10 may comprise setting up S103 (e.g. defining, specifying) entry and/or exit conditions for the area and/or for the sub-areas, i.e., conditions specifying entry into and/or exit from the monitored area and/or the sub-areas. The entry and/or exit conditions may specify at least one of the following: an entrance into and/or exit from the area and/or the sub-areas; and/or direction of entering and/or exiting the area and/or the sub-areas. With respect to entering and/or exiting the area and/or the sub-area, it may be defined that an entering or exiting event occurs, if at least one corresponding detection line of the corresponding area or sub-area is crossed. Additionally, with respect to crossing, it may be specified that an entering or exiting event occurs if at least one corresponding detection line of the corresponding area or sub-area is crossed from one side of the line to the other side of the line and/or if at least one corresponding detection line of the corresponding area or sub-area is crossed in at least one specified direction.

Further, the entry and/or exit conditions may be set up with regard to the observation area of the apparatus for monitoring presence of persons. For example, the entries and/or exits may be specified with regard to the observation area. Further, the crossing of at least one corresponding detection line may be defined in and/or with regard to the observation area of the apparatus.

Thus, the information 1 required for performing the monitoring may comprise at least one of the following: information on at least two subdivided sub-areas, information on detection lines, the directional relationships, and/or the entry and/or exit conditions. The apparatus for monitoring presence of persons may comprise at least one memory or data/information storing unit configured to store the information 1. When the processing S10 of information 1 is executed partially or entirely by the apparatus for monitoring presence of persons, at least one processor or processing unit of the apparatus may be configured to perform the processing S10.

Turning back to FIG. 1, on the other side thereof, when the information 1 required for performing the monitoring is available, detection S11 of exiting and/or entering events is executed by use of the information 1 required for performing the monitoring. Detection step S11 is executed by the apparatus for monitoring presence of persons. For this purpose, at least one processor or processing unit of the apparatus may be configured to perform the detection step S11. As mentioned above, the information 1 required for performing the monitoring may be kept (e.g. stored) by the apparatus, e.g., at least during executing the monitoring. Detection step S11 is executed by use of a set of detection lines. For each of the sub-areas to be monitored, at least one detection line is defined. The detection line may be defined with regard to a boundary of the corresponding sub-area. The detection line may be defined with regard to an entry and/or exit of the corresponding sub-area. Further, the detection line may be defined with regard to a boundary of the coverage area, e.g., in or at the coverage area. When a moving person crosses a detection line towards or into a sub-area, an entry event for the sub-area is detected S11. When a moving person moves so that crossing a detection line towards or into a sub-area can be expected (e.g., by calculating, tracing and/or analyzing movement trajectory of the person), an (expected) entry event for the sub-area is detected S11. When a moving person crosses a detection line by moving out of or away from the sub-area, an exit event is detected S11 for the sub-area. When a moving person moves so that crossing a detection line by moving out of or away from the sub-area can be expected (e.g., by calculating, tracing and/or analyzing movement trajectory of the person), an (expected) exit event is detected S11 for the sub-area. Detection step S11 may use directional relationships for determining in which direction a person is moving. From the location information, and from the at least one relation between an entry and/or exit of the area and a sub-area and/or from the above-outlined paths, it can be derived, which sub-areas could represent the target area of the moving person and/or whether a moving person will enter, has entered, will exit or has exited a sub-area (e.g. by taking into consideration detection lines and calculating whether the moving person will or has crossed the detection line). Further, the detection step S11 may use entry and/or exit conditions for determining whether a moving person has entered or will enter a sub-area and/or whether the moving person has exited or will exit a sub-area.

After detecting S11 at least one exiting and/or entering event, occupancy relevant information is computed S12. For computing S12, the at least one detected S11 exiting and/or entering event is used. The apparatus for monitoring presence of persons in the area provides information about the at least one (expected and/or already performed) exiting and/or entering event (e.g. related to the observation area). Further, said apparatus may provide information on the boundary of the observation area and/or on the corresponding detection line crossed or expected to be crossed (e.g. the direction with which the event is associated). The computing S12 of the occupancy-relevant information may comprise at least one of the following: counting the number of persons in the area and/or in at least one of the sub-areas; calculating the state of occupancy of the area and/or of at least one of the sub-areas, wherein the state of occupancy may indicate whether the area or the sub-area is occupied or not and/or the extent to which the area or the sub-area is occupied (e.g. expressed as a percentage); monitoring dynamics or changes of the occupancy of the area and/or of at least one of the sub-areas over a time period, wherein said dynamics or changes may be outputted by indicating how often and/or how long the area or the sub-area was occupied or not and/or by indicating the extent to which the area or the sub-area was occupied (e.g. as a percentage, as an area specification indicating a lower and a higher extent of occupation and/or as an average percentage). As entering and/or exiting events may also comprise events which are expected to be executed or occur, the occupancy-relevant information may be faulty in the case of false event predictions. Therefore, the computing S12 of the occupancy-relevant information may comprise correcting said information. For example, someone is leaving a sub-area for which the count was zero. Then, the count of the adjacent sub-area is reduced by one (if this leads to a more consistent overall system state, i.e., occupancy/count information for the monitored area). The computing S12 of the occupancy-relevant information may be executed, for example, by the apparatus arranged for monitoring presence of persons or by a monitoring system comprising said apparatus. When the computing S12 of the occupancy relevant information is executed by the apparatus for monitoring presence of persons, at least one processor or processing unit of the apparatus may be configured to perform the computing S12. The computing S12 of the occupancy allows identification of (expected and/or actual) occupancy and/or of (expected and/or actual) continuation of the occupancy. Subsequently, the computed S12 occupancy-relevant information may be used for controlling S13 operation of an apparatus installed in the area and/or in at least one of the sub-areas and controlled with regard to the occupancy. For this purpose, said computed S12 information may be provided to a controller or a controlling apparatus arranged to control S13 the controlled apparatus. The controlled apparatus may be, for example, a lighting apparatus or system, an air conditioning apparatus or system, a heating apparatus or system etc. If, for example, occupancy-relevant information is computed S12 in view of an expected entering and/or exiting event, the controlled apparatus is controlled in expectation of said event. For example, lighting and/or another corresponding apparatus may be switched on or operated before the person enters the corresponding sub-area. Otherwise, if, for example, occupancy relevant information is computed S12 in view of an actually given entering and/or exiting event, the controlled apparatus is controlled in consequence of said event. In this case, for example, lighting and/or another corresponding apparatus may be switched on or off, i.e., operated (directly) after the person enters or exits the corresponding sub-area.

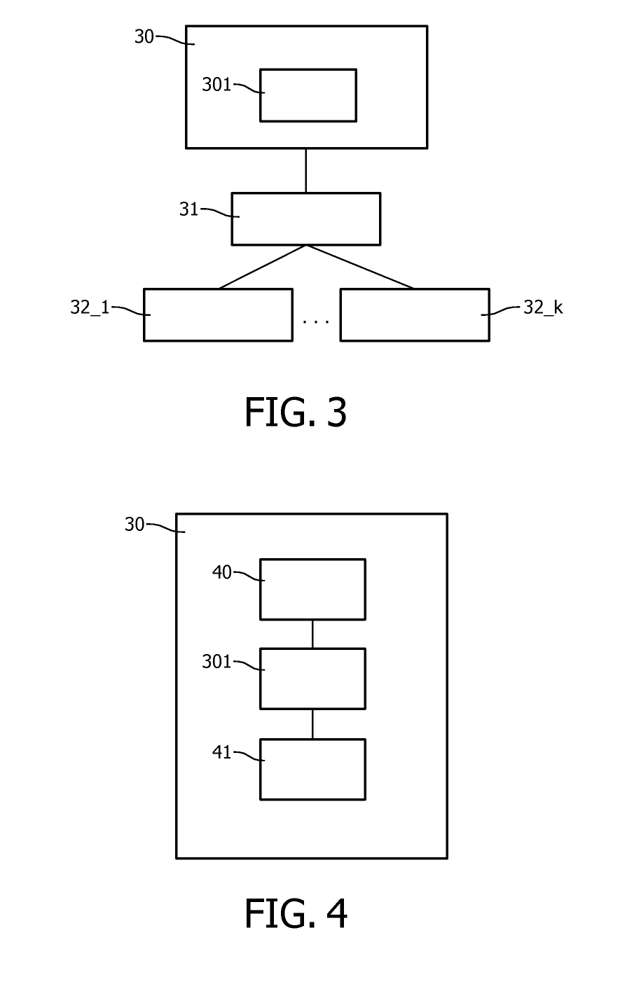

FIG. 3 illustrates an arrangement utilizing the step of monitoring presence of persons in an area according to an embodiment of the present invention. The arrangement comprises a system 30 arranged for monitoring presence of persons in an area. The system 30, in turn, comprises an apparatus 301 arranged for monitoring presence of persons in the area. After computing occupancy-relevant information, the system 30 provides said information to a controller 31 configured as indicated above. The controller 31 then controls at least one controlled apparatus 32_1 to 32_k based on the provided occupancy-relevant information, wherein k is an integer and 1≦k.

FIG. 4 illustrates a system 30 arranged for monitoring presence of persons in an area according to an embodiment of the present invention. The system 30 comprises the apparatus 301 for monitoring presence of persons in the area. Further, the system may comprise an information processing apparatus 40 arranged to process S10 and provide the information 1 required for performing the monitoring. According to the present embodiment, the information processing apparatus 40 provides the processed information 1 to the apparatus 301 for monitoring presence of persons in the area, which detects S11 at least one entering and/or exiting event. According to the present embodiment, the apparatus 301 for monitoring presence of persons in the area may provide the detected S11 at least one entering and/or exiting event to an occupancy-relevant information computing apparatus 41 arranged to compute S12 occupancy-relevant information by use of the detected S11 at least one entering and/or exiting event. The occupancy-relevant information computing apparatus 41 may provide the computed S13 information to the controller 31.

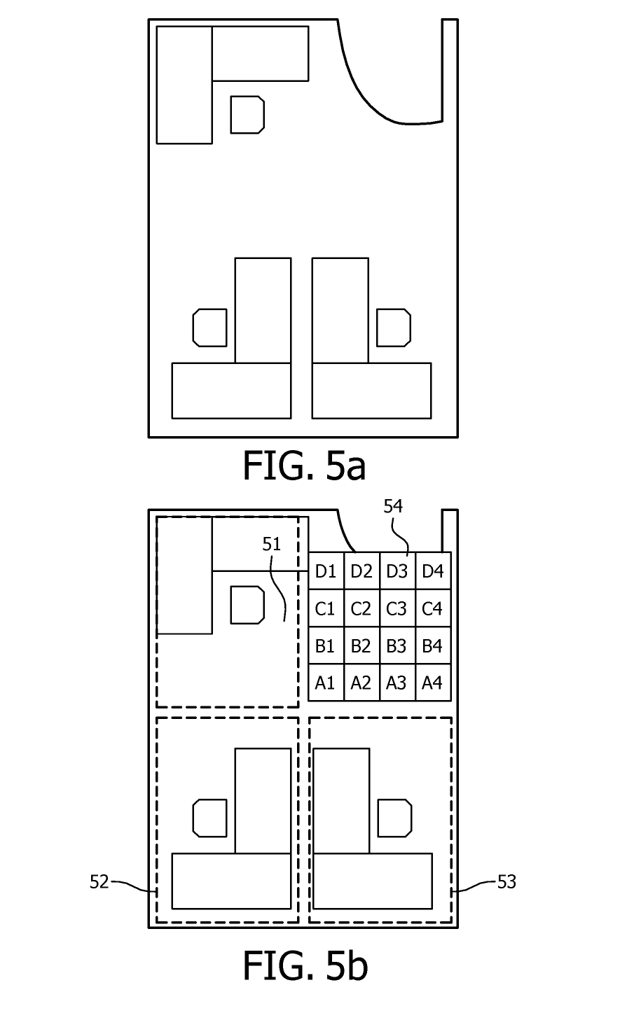

FIGS. 5a and 5b illustrate subdividing S101 an area into sub-areas 51, 52, 53 according to an embodiment of the present invention. According to the present embodiment, an office room is provided as an area to be monitored. The office has, for example, three workplaces indicated by desks. The monitoring is performed with regard to the three workplaces or task areas. Identification of users in task areas may be important for adjusting, for example, light and/or blinds controls. The total number of persons in the area and/or in the sub-areas may be used, for example, for room-level light control, temperature control and/or for ventilation or air adjustments. As can be derived from FIG. 5b, the office area is subdivided S101 into three sub-areas 51, 52, 53, which correspond to the task areas (e.g. office desks). Here, it has to be pointed out that several ways of subdividing S101 as an area are possible. Thus, for example, also sub-areas corresponding to a specific utilization (e.g.

corridor arm etc.) may be created by subdividing S101. According to the present embodiment, the apparatus 301 for monitoring presence of persons in the office is located in the entry/exit area of the office. Further, the apparatus 301 has an observation area, which is indicated by the reference sign 54. According to the present embodiment, the observation area 54 is divided into segments D1 to D4, C1 to C4, B1 to B4 and A1 to A4 for better monitoring and detection of entry and/or exit events. According to the present embodiment, the segments have the shape of rectangles. Here, also further shapes of segments may be used according to the present invention. For example, in general, the segments may be polygons. With respect to this, it has to be noted that it is not mandatory for the observation area 54 to take the form of a grid. It is possible that the observation area 54 is not divided into segments.

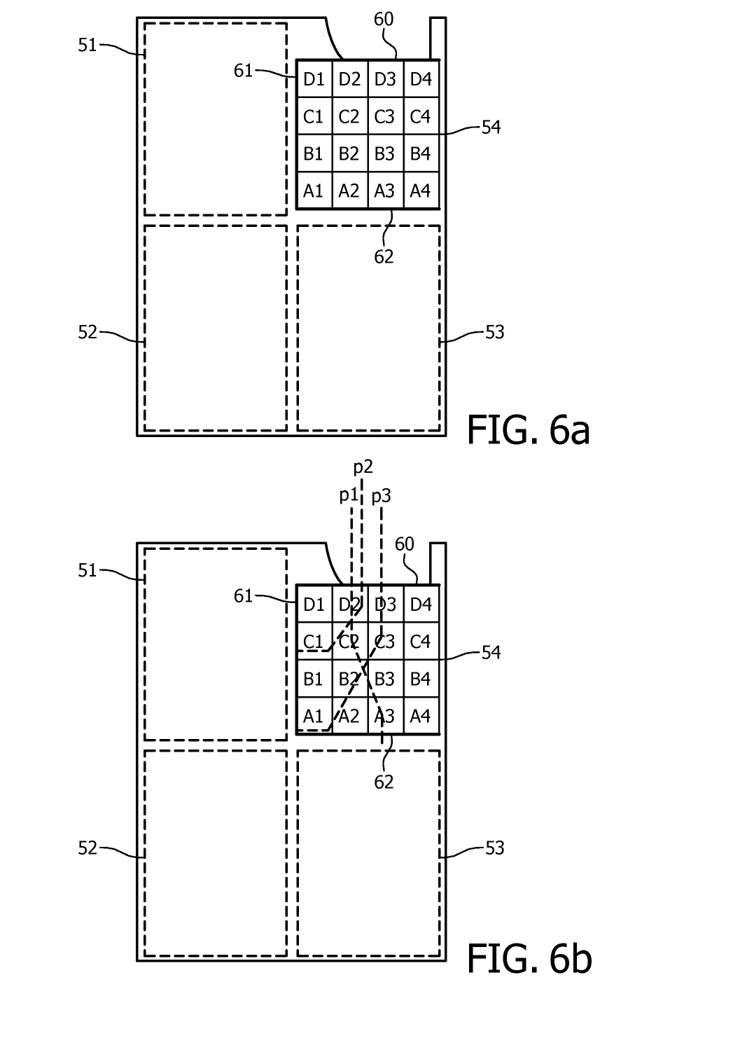

FIGS. 6a and 6b illustrate detection S11 of entering and/or exiting events according to the embodiment of the present invention. The embodiment of FIGS. 6a and 6b is a continuation of the embodiment of FIGS. 5a and 5b. At first, detection lines 60, 61, 62 are associated to the sub-areas 51, 52, 53. According to the present embodiment, the detection lines 60, 61, 62 are formed at borders of the observation area 54 of the apparatus 301 for monitoring presence of persons in the office. The detection lines 60, 61, 62 mark entries and/or exits of the sub-areas 51, 52, 53. The detection line 60 belongs to the entry/exit of the office. According to the present invention, detection lines may mark also entries and/or exits of the area. The detection line 61 belongs to the sub-areas 51 and 52. The detection line 62 belongs to the sub-area 53. Distinguishing between entry and/or exit events for the sub-area 52 may be implemented, for example, by taking into consideration the time of entry and/or exit events, movement direction of a person, directional relationships and/or entry and/or exit conditions. Additionally, distinguishing between entry and/or exit events for the sub-areas 51 and 52 may be performed also by introducing finer divided detection lines. If the apparatus 301 for monitoring presence of persons in the area is not able to perform said distinguishing step, the sub-areas 51 and 52 may be considered as one sub-area, e.g., the two sub-areas 51, 52 may be joined into one sub-area.

Furthermore, according to the present invention, in general, the apparatus 301 for monitoring presence of persons may have tracking capabilities within the monitored or observed area 54, i.e., it may be arranged for tracking a moving person in the observation area 54. In FIG. 6b, trajectories p1, p2 and p3, determined by tracing persons moving in the observation area 54 by means of the monitoring apparatus 301, lead to the following sub-area or task-area status information: one person is located in the sub-area 51 (see trajectory p2); one person is located in the sub-area 52 (see trajectory p3); and one person is located in the sub-area 53 (see trajectory p1). The detection step S11 comprises calculating a movement trajectory of a person (moving in the observation area). Then, it is determined whether the person has crossed at least one detection line 60, 61, 62. By use of the information on crossing of detection lines 60, 61, 62, the current location of the person in the area is detected S11. For said detection S11 use may also be made of predefined directional relationships 1 and/or entry and/or exit conditions 1.

In the present embodiment, an occupancy count for the sub-area 53 is increased S12 after detecting S11 the following event sequence: entry into the observation area via detection line 60, exit from the observation area (entry into the sub-area 53) via the detection line 62 (see trajectory p1). The same holds for the sub-area 51: entry into the observation area via detection line 60, exit from the observation area (entry into the sub-area 51) via the detection line 61 (see trajectory p2). For the trajectory p3, the same event sequence holds as for the trajectory p2. However, for the trajectory p3, the time interval between the entry event via the detection line 60 and the exit event via the detection line 61 is distinctly higher than for trajectory p2. With respect to this, it is assumed that if the time interval between crossing two detection lines 60, 61, i.e., between two entry and/or exit events, for a first trajectory p3 is much higher (e.g. higher with regard to a certain factor and/or certain time threshold) than for a second trajectory p2, the moving person has entered the sub-area 52, being at a larger distance than the sub-area 51 entered via the first trajectory p3. This holds, for example, if a detection line, like the line 61, is associated with more than one sub-area, here—sub-areas 51 and 52.

Thus, according to the present embodiment, the time interval between an entry event at a particular detection line 60, 61, 62 (e.g., time interval between crossing the particular detection line 60, 61, 61) and the exit event at another detection line 60, 61, 62 (e.g., crossing the another detection line 60, 61, 62) can be measured and used to refine the directional information, i.e., to improve the determining of the sub-area, which has been entered or exited. This refining of directional information may be implemented in any of the embodiments of the present invention.

According to an embodiment, which may also be combined with the present embodiment (e.g. for improving the detection S11 results), the sub-area, into which a person has moved, may be determined S11 also by increasing the resolution of detection lines 60, 61, 62 such that, when referring to FIG. 6b, the exit at the lower left corner of the observation area 54 can be detected as a (potential) entry into the sub-area 53. The resolution of the detection lines 60, 61, 62 may be increased with regard to at least one of the detection lines 60, 61, 62. In this way, computing space and time may be saved. Similarly, it is possible to decrease the resolution of detection lines 60, 61, 62, e.g., when a rougher detection S11 is sufficient (for example, after detecting S11 with increased resolution). Increasing the resolution of at least one detection line 60, 61, 62 comprises subdividing the detection line 60, 61, 62 into segments, i.e., into at least two (smaller) detection lines. Thereby, entry and/or exit conditions may be introduced with a higher special resolution, as for (each of) the smaller detection lines corresponding conditions are specified. In this way, a more concrete, detailed and accurate view on the corresponding entry and/or exit area is provided. Decreasing the resolution of at least one detection line 60, 61, 62 refers to the opposite of said increasing and comprises joining at least two of the detection lines 60, 61, 62 into one (larger) detection line 60, 61, 62. Thereby, entry and/or exit conditions may be introduced with a lower special resolution. Further, a more efficient detection step S11 can be performed, e.g., requiring less computation space and time. The above-described increase and/or decrease of the resolution of at least one detection line 60, 61, 62 may be applied in any of the embodiments of the present invention.

Further, when performing detection step S11, a higher spatial resolution may be introduced. This may be executed by a finer sub-division of the observation area 54 into grids or segments D1 to D4, C1 to C4, B1 to B4 and A1 to A4. In this case, new grids or segments are smaller than the current segments or grids D1 to D4, C1 to C4, B1 to B4 and A1 to A4 used before said sub-division. For said detection S11, the new grids or segments are then used. The finer new grids or segments allow a more accurate tracing of persons. Further, they may have more detailed information on the directional relationships and/or on the entry and/or exit conditions. Similarly, a lower spatial resolution may be introduced, e.g., if it is enough to perform detection S11 on a coarser grained level. The lower spatial resolution may be introduced by a rougher sub-division of the observation area 54 into grids or segments D1 to D4, C1 to C4, B1 to B4 and A1 to A4. In this case, new grids or segments are larger than the current segments or grids Dl to D4, C1 to C4, B1 to B4 and A1 to A4 used prior to the sub-division. For said detection S11, the new grids or segments are then used. The rougher new grids or segments allow a more general and less space and computing time-consuming tracing of persons. Further, the new grids or segments may have more general information on the directional relationships and/or on the entry and/or exit conditions. The above-described increase and/or decrease of the spatial resolution may be applied in any of the embodiments of the present invention. In the case that an imaging sensor is used as the apparatus 301 for monitoring presence of persons in the area, if the spatial resolution of the imaging sensor 301 is high enough to allow object tracking within the observation area 54, a higher spatial resolution for the direction detection can be achieved, which may be translated into mapping to finer granular sub-areas 51, 52, 53. For a lower spatial resolution, the opposite holds—a lower spatial resolution for the direction detection can be achieved, which may be translated accordingly into mapping to rougher granular sub-areas 51, 52, 53.

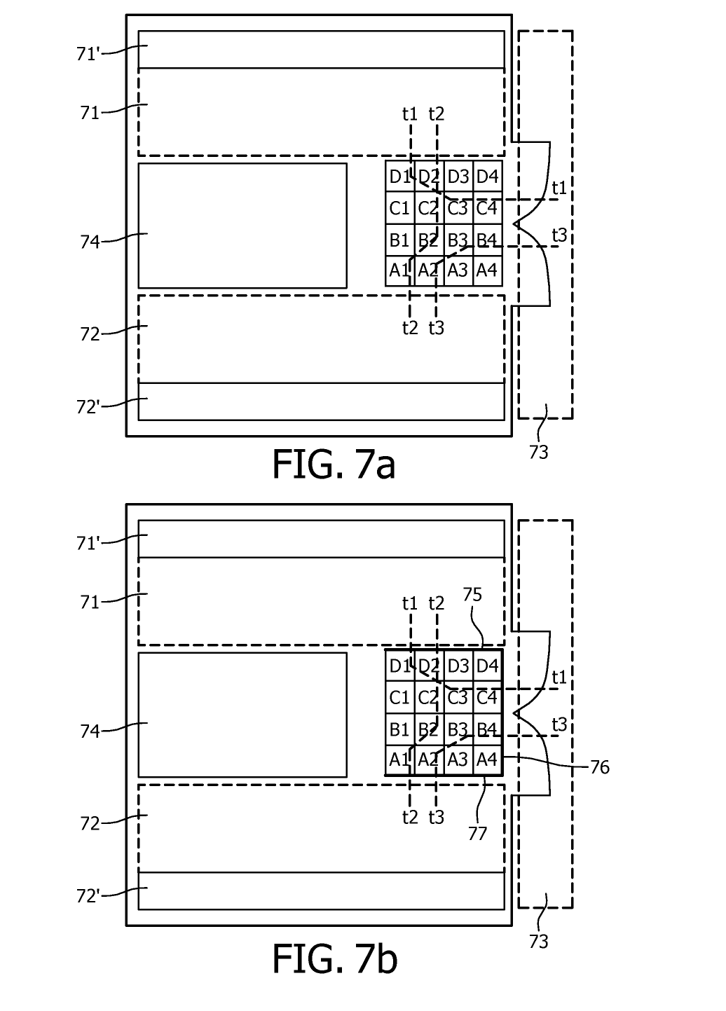

FIGS. 7a and 7b illustrate detection S11 of entering and/or exiting events according to an embodiment of the present invention. The detection step S11 according to the present embodiment is performed in the same way as the detection step S11 described with regard to the above embodiment. FIGS. 7a and 7b show that the present invention allows counting persons entering and/or leaving an entire building. Additionally, presence in particular corridor areas may be distinguished (e.g. entering and/or leaving of the particular corridor areas). According to the present embodiment, a floor of a building represents the area to be monitored. The floor is subdivided into three sub-areas 71, 72 and 73, wherein the sub-areas 71 and 72 comprise office areas 71′ and 72′ and the sub-area 73 represents an entrance/exit area. Further, a storage room 74, which according to the present embodiment is not monitored since it cannot be entered and exited from the observation area and, hence, does not represent a sub-area, is provided on this floor. The coverage area of the monitoring apparatus 301 is represented by the grid D1 to D4, C1 to C4, B1 to B4 and A1 to A4. A detection line 75 is associated with the sub-area 71, a detection line 76 is associated with the sub-area 73 and a detection line 77 is associated with the sub-area 72. By means of the detection lines 75, 76, 77, persons moving as exemplarily indicated by trajectories t1, t2, t3 may be distinguished. This enables overall occupancy and the number of people per building partition (e.g. floor) to be computed S12 as a potential control system input for controlling S13 operation of controlled apparatus 32_1, . . . , 32_k. Further, according to the present embodiment, also switching of persons between the sub-area 71 and the sub-area 72 (trajectory t2) may be detected S11 and can be used when determining S12 the count of persons present per partition.

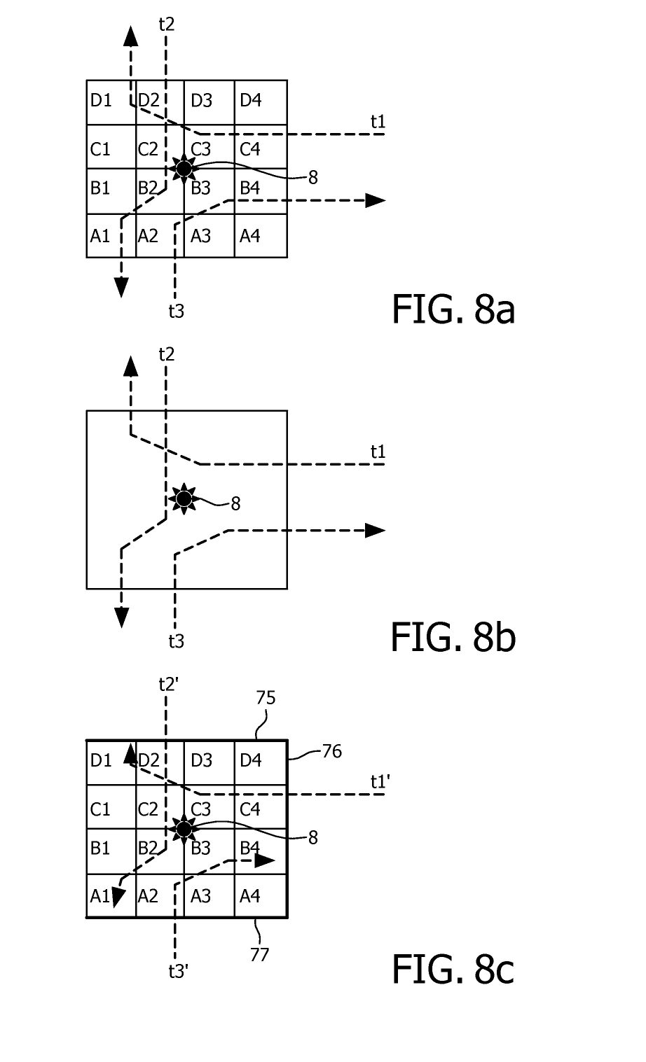

FIG. 8a shows the observation area of FIGS. 7a and 7b in more detail. The monitoring apparatus is indicated by the reference sign 8. As can be seen from FIG. 8a and as can be derived from each of the embodiments described herein, the present invention allows tracing of a plurality of persons in an area. The persons may be traced simultaneously. According to FIG. 8a, three persons are detected via the trajectories t1, t2, t3. The observation area is implemented as a grid. According to the present embodiment, 16 grids or segments D1 to D4, C1 to C4, B1 to B4 and A1 to A4 are used. When performing detection step S11, it can be determined, for example, that the person with trajectory t2 entered the observation area via the grid or segment D2 and exited the observation area via the grid or segment A1. By use of this information in connection with the detection lines 75, 76, 77 associated with sub-areas 71, 72, 73, the location of persons is detected S11. Additionally, also the directional relationships and/or the entering and/or exiting conditions may be used. With respect to this, the directional relationships and/or the entering and/or exiting conditions may be specified with regard to the grids or segments D1 to D4, C1 to C4, B1 to B4 and A1 to A4. The grids or segments D1 to D4, C1 to C4, B1 to B4 and A1 to A4 allow subdivision into a number of entrances and/or exits for sub-areas. Further, the present invention allows reliable path tracking within the observation area. For example, it is possible to detect the moving trajectories t1, t2, t3 of persons even when the trajectories intersect, see t1 and t2 in FIG. 8a. As regards counting S12 persons in the area, with regard to FIG. 7b and FIG. 8a, trajectory t1 causes the number of persons in the area to increase by one, trajectory t2 does not influence the count as the person remains in the area, trajectory t3 causes the number of persons in the area to decrease by one.

FIG. 8b illustrates an observation area according to an embodiment of the present invention referring by way of example to FIGS. 7a and 7b. The observation area is arranged like the observation area of FIG. 8a. However, according to the present embodiment, the observation area does not comprise a grid. Moving trajectories t1, t2, t3 are analyzed without using segments of the observation area. In this way, a rougher detection S11 than the detection of FIG. 8a is executed according to the present embodiment.

FIG. 8c illustrates an exemplary detection step S11 carried out in the observation area of FIGS. 7a and 7b. Said detection step S11 comprises the detecting of expected entering and/or exiting events, as can be seen by considering trajectories t1′, t2′ and t3′, which do not cross the detection lines 75, 76, 77 and end in the observation area. When analyzing the development of trajectory t1′ (i.e., performing trajectory or path tracking) in the observation area and/or when analyzing motion of a person with regard to the detection lines 75, 76, 77, particularly, with regard to the detection line 75, in the observation area, it may be detected S11 that an entering event into the sub-area 71 can be expected. When analyzing the development of trajectory t2′ (i.e., performing trajectory or path tracking) in the observation area and/or when analyzing motion of a person with regard to the detection lines 75, 76, 77, particularly, with regard to the detection line 77, in the observation area, it may be detected S11 that an entering event into the sub-area 72 can be expected. When analyzing the development of trajectory t3′ (i.e., performing trajectory or path tracking) in the observation area and/or when analyzing movement of a person with regard to the detection lines 75, 76, 77, particularly, with regard to the detection line 76, in the observation area, it may be detected S11 that an entering event into the sub-area 73 can be expected. The process of analyzing trajectories t1′, t2′, t3′, i.e., performing trajectory t1′, t2′, t3′ or path tracking, may be done by use of the information 1 required for performing the monitoring as described by way of example hereinabove. Accordingly, also analyzing motion of a person with regard to the detection lines 75, 76, 77 may be performed by use of the information 1 required for performing the monitoring. In general, the detection S11 of expected entering and/or exiting events is executed like or in the same manner as the detection step S11 of already performed entering and/or exiting events, with this difference that it is detected S11 in which direction the person will move next, for example, which detection line 75, 76, 77 the person will (most probably) cross.

Here, it has to be pointed out that the present invention allows to detect S11 actually performed and/or expected entering and/or exiting events.

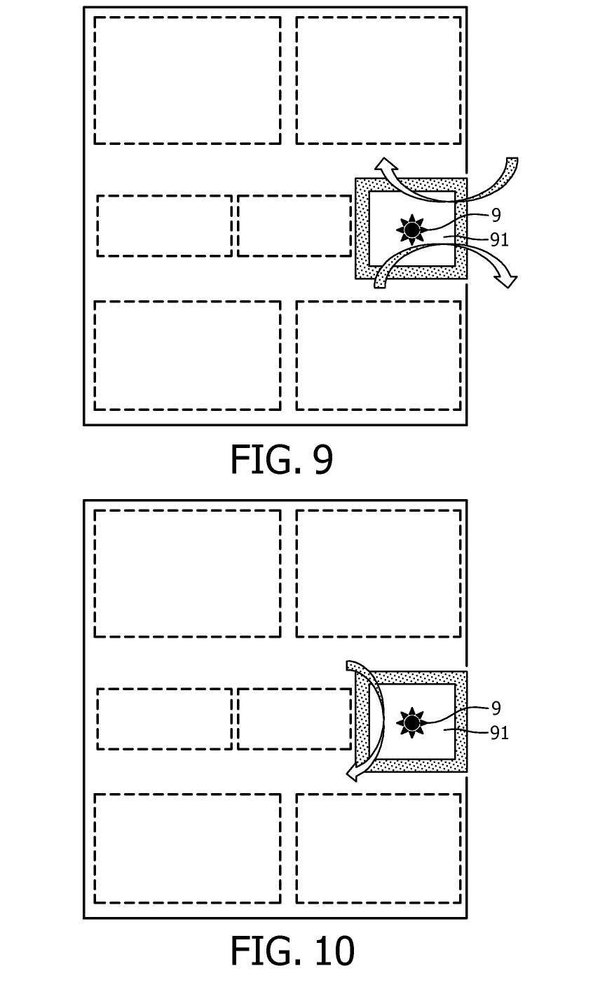

FIG. 9 illustrates monitoring presence of persons in an area according to an embodiment of the present invention. According to FIG. 9, the area comprises several rooms indicated by boxes drawn in dashed lines. The apparatus 9 for monitoring presence of persons in the area is arranged like the above-described apparatuses 301 and 8. According to the present embodiment, the monitoring apparatus 9 detects S11 persons entering and/or leaving the area by use of its observation area 91, which is implemented and/or arranged like the above-described observation areas. By use of the present invention, reliable detection S11 of entering and/or exiting persons is ensured. Said reliable detection S11 is a basis for and allows reliable computing S12 of occupancy information, e.g., the counting of persons in the area.

FIG. 10 illustrates monitoring presence of persons in an area according to an embodiment of the present invention. According to FIG. 10, the area comprises several rooms indicated by boxes drawn in dashed lines. The apparatus 9 for monitoring presence of persons in the area is arranged like the above-described apparatuses. According to the present embodiment, the monitoring apparatus 9 detects S11 persons moving in the corridor but not persons entering and/or leaving the area by use of its observation area 91, which is implemented and/or arranged like the above-described observation areas. The movement of the persons in the corridor does not influence the occupancy information, e.g., the number of persons in the overall area. However, this case is crucial to detect whether the distinction in person count per corridor segment is important (as indicated in the embodiment described before using FIGS. 7a and 7b).

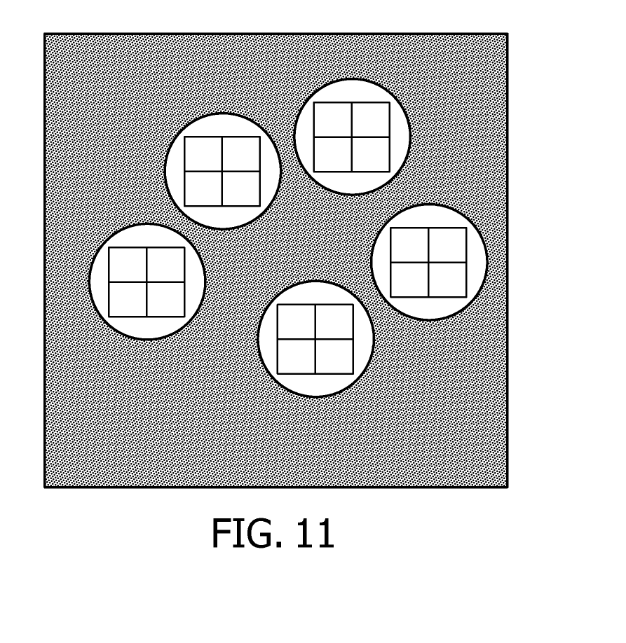

FIG. 11 shows an IR heat image with identified persons, which may be used for detection S11 according to an embodiment of the present invention. The apparatus 301, 8, 9 for monitoring the presence of persons in an area may be, for example, an ultra-low-resolution imaging sensor (e.g. infrared or camera-based). The sensor 301, 8, 9 may have object/person tracking capabilities within its observation area 54, 91. FIG. 11 illustrates by way of example an IR heat image that is used by the sensor 301, 8, 9 for detecting S11. The white encircled pixels indicate persons detected, identified and monitored in the observation area 54, 91.

The present invention as described above has a plurality of different application areas like lighting and areas related to lighting in building controls, energy and building utilization monitoring (smart energy venture), service opportunities that require accurate knowledge of the building usage or continuous monitoring and surveillance of the building operations.

The present invention may be used for non-permanent installations. For example, it may be implemented in monitoring applications (e.g. non-permanent usage profile acquisition) to determine area or room occupancy patterns (e.g., number of persons, dynamics of presence profiles (frequency and duration of exiting and/or entering events)).

Further, the present invention may be used also for permanent installations. For example, it may be used in real-time controls for lighting and/or HVAC (Heating, Ventilating and Air Conditioning) applications (e.g., to switch and/or dim lights at segment level (sub-areas)) or for demand-led HVAC control. Further, it may be used, for example, in long-term data acquisition and monitoring applications for facility management (FM) to determine area or room usage and consumption (ongoing commissioning).

As can be derived from the aforesaid, the present invention proposes a method for area segregation and a tailored person localization concept that uses directional movement detection (e.g. by using a directional movement sensor as an apparatus for monitoring presence or persons in an area). The coverage area, i.e., the observation area of the monitoring apparatus or sensor, may be smaller than the area to be monitored. Further, the coverage area, i.e. the observation area of the monitoring apparatus or sensor, does not necessarily cover the sub-areas with the occupants. The method exploits information on entering and exiting events for sub-areas to determine the occupancy state of the sub-areas. This can be derived from directional movement sensing/detecting without direct monitoring/surveillance of sub-areas itself. Thus, the sub-area of an occupant is preserved as privacy shell. This low-cost sensing approach can provide essential information for personalized controls at suitable, correlated granularity level (that maps to the sub-areas). Detection step S11 and the sensor 301, 8, 9 may be based on standard technology, e.g. IR sensing. In this case, no new sensing modality or technology and associated risks have to be managed.

Summarizing, for monitoring presence of persons in an area, the area is subdivided into at least two sub-areas and, for each of the at least two sub-areas, at least one detection line is defined with regard to a boundary of the corresponding sub-area. The detection line marks an entry and/or exit of the corresponding sub-area. Within the scope of the monitoring, it is detected whether a moving person is entering or exiting the corresponding sub-area by use of the at least one detection line of the corresponding sub-area and/or whether the moving person is expected to enter or exit the corresponding sub-area by use of the at least one detection line of the corresponding sub-area.

It is obvious that the above-described embodiments can be combined in various ways. Thus, for example several combinations of information required for monitoring may be used for the detection step. Further, said detection step may use at least one of: subdividing the observation area into more or fewer segments than currently used or using the undivided observation area—i.e. without segments; subdividing at least one detection line into more lines than currently used and/or joining at least two detection line into one detection line; executing analysis of trajectories of moving persons in the observation area; determining actually performed and/or expected entry and/or exiting events; subdividing the area into more or fewer sub-areas than currently used. The present invention allows several combinations of the above-outlined steps or actions for executing monitoring. By means of the above described monitoring, efficient, flexible, cost and resource-saving, privacy-considering and reliable monitoring of presence of persons in an area is enabled. The reliability of the monitoring according to the present invention enables also reliable and correct operation of devices in the monitored area, as said operation is based on the detection and monitoring results.

1. An apparatus arranged for monitoring presence of persons in an area:
wherein the area is subdivided into at least two sub-areas and
wherein, for each of the at least two sub-areas, at least one detection line of an observation area is defined with regard to a boundary of the corresponding sub-area, the detection line marking an entry and/or exit of the corresponding sub-area, and
the apparatus being configured to execute a detection step to detect whether a moving person is entering or exiting the corresponding sub-area by use of the at least one detection line of the corresponding sub-area and/or to detect whether the moving person is expected to enter or exit the corresponding sub-area by use of the at least one detection line of the corresponding sub-area; and,
wherein the apparatus is further configured to switch between high spatial resolution and low spatial resolution by increasing and decreasing, respectively, a resolution of the at least one detection line and/or by subdividing the observation area of the apparatus into smaller and larger segments.

2. The apparatus according to claim 1, wherein the apparatus is configured to execute at least one of the following:
detect the person as entering the corresponding sub-area, when the person is crossing the at least one detection line of the corresponding sub-area by moving towards or into the corresponding sub-area;
detect the person as exiting the corresponding sub, when the person is crossing the at least one detection line of the corresponding area by moving out of or away from the corresponding sub-area;
detect the person as being expected to enter the corresponding sub, when it is calculated that the person moves to the at least one detection line of the corresponding sub-area by moving towards the corresponding sub-area;
detect the person as being expected to exit the corresponding sub-area, when it is calculated that the person moves to the at least one detection line of the corresponding area by moving towards an exit of the corresponding sub-area;
determine whether the person is entering or exiting the area;
determine whether the person is expected to enter or exit the area;
determine whether the person is moving from one sub-area to another sub-area; and/or
determine whether the person is expected to move from one sub-area to another sub-area.

3. The apparatus according to claim 1, wherein the apparatus is configured to execute the detection step by use of at least one of the following:
a set of directional relationships between the area and the at least two sub-areas; and/or
a set of entry and/or exit conditions for the area and/or the at least two sub-areas.

4. The apparatus according to claim 3, wherein:
at least one directional relationship of the set of directional relationships specifies at least one of the following: location of the corresponding sub-area in the area, and/or at least one path leading to the corresponding sub-area in the area; and/or
at least one of the entry and/or exit conditions specifies at least one entrance and/or at least one exit of the area and/or of the corresponding sub-area.

5. The apparatus according to claim 1, wherein the apparatus is configured to execute the detection step by calculating a movement trajectory of the person.

6. The apparatus according to claim 1, wherein the apparatus is configured to execute the detection step by measuring a time interval between a crossing of one detection line and a further crossing of a further detection line for entering the corresponding sub-area and by using the measured time interval for calculating a target sub-area, towards which the person moves.

7. The apparatus according to claim 1, wherein the apparatus is arranged to monitor presence of persons in the observation area of the apparatus.

8. The apparatus according to claim 7, wherein:
the at least one detection line is defined with regard to a border of the observation area;
the set of directional relationships is specified with regard to the observation area;
the at least one path is comprised in the observation area;
the set of directional relationships comprises at least one directional relationship specifying the direction to the location of the corresponding sub-area in the observation area;
the set of entry and/or exit conditions is specified with regard to the observation area; and/or
the movement trajectory is calculated in the observation area.

9. The apparatus according to claim 7, wherein the observation area is implemented as a grid.

10. The apparatus according to claim 9, wherein for the switching between high spatial resolution and low spatial resolution, the apparatus is configured to:
recalculate the grid of the observation area by subdividing the grid into smaller segments than the segments currently used in the grid and/or by subdividing the grid into larger segments than the segments currently used in the grid;
subdivide the detection line into at least two new detection lines for using the at least two new detection lines for detection purposes (S11) with high spatial resolution; and/or
join at least two detection lines into one detection line for using the one detection line for detection purposes with low spatial resolution.

11. The apparatus according to claim 1, wherein the apparatus comprises a directional movement sensor, which is configured to execute the detection step, wherein the directional movement sensor may be an ultra-low-resolution imaging sensor, wherein the ultra-low-resolution imaging sensor may be an infrared sensor and/or a camera-based sensor.

12. A method of monitoring presence of persons in an area:
wherein the area is subdivided into at least two sub-areas and
wherein, for each of the at least two sub-areas, at least one detection line of an observation area is defined with regard to a boundary of the corresponding sub-area, the detection line marking an entry and/or exit of the corresponding area, and
the method comprises detecting whether a moving person is entering or exiting the corresponding sub-area by use of the at least one detection line of the corresponding sub-area and/or whether the moving person is expected to enter or exit the corresponding sub-area by use of the at least one detection line of the corresponding sub-area; and,
wherein further a spatial resolution is switchable between high spatial resolution and low spatial resolution by increasing and decreasing, respectively, a resolution of the at least one detection line and/or by subdividing the observation area into smaller and larger segments.

13. A system comprising an apparatus arranged for monitoring presence of persons in an area according to claim 1.

14. The system according to claim 13, wherein the system is configured to compute information on presence of persons in the area and/or in the sub-areas by executing at least one of the following:
counting the number of persons in the area and/or the number of persons in at least one of the at least two sub-areas;
calculating the state of occupancy of the area and/or of at least one of the at least two sub-areas;
monitoring changes of the occupancy of the area and/or of at least one of the at least two sub-areas over a time period;
correcting, by use of a current detecting result, at least one of the following: the number of persons in the area and/or the number of persons in at least one of the at least two sub-areas, the state of occupancy of the area and/or of at least one of the at least two sub-areas;
and/or wherein the system is configured to compute information on expected presence of persons in the area and/or in the sub-areas by executing at least one of the following;
calculating an expected number of persons in the area and/or an expected number of persons in at least one of the at least two sub-areas;
calculating an expected state of occupancy of the area and/or of at least one of the at least two sub-areas;
correcting, by use of a current detecting result, at least one of the following: the expected number of persons in the area and/or the expected number of persons in at least one of the at least two sub-areas, the expected state of occupancy of the area and/or of at least one of the at least two sub-areas.

15. The system according to claim 13, wherein the system is configured to transmit the computed information on presence of persons in the area and/or in the sub-areas to a controlling apparatus, which is configured to control at least one controlled apparatus installed in the area by adjusting operation of the controlled apparatus with regard to the presence of the persons in the area and/or in the at least two sub-areas and/or with regard to computed expected presence of the persons in the area and/or in the at least two sub-areas.
